(19) United States
(12) Patent Application Publication
(10) Pub. No.: US 2013/0193801 A1
(43) Pub. Date: Aug. 1, 2013

(54) CONICAL SPRING WASHER FOR MOUNTING A STATOR IN THE HOUSING OF AN ELECTRICAL MACHINE

(71) Applicants: Joerg Schmid, Achern (DE); Samir Mahfoudh, Buehl (DE); Christoph Heier, Iffezheim (DE); Claudius Muschelknautz, Buehl (DE); Tilo Koenig, Buehl (DE); Jerome Thiery, Strasbourg (FR)

(72) Inventors: Joerg Schmid, Achern (DE); Samir Mahfoudh, Buehl (DE); Christoph Heier, Iffezheim (DE); Claudius Muschelknautz, Buehl (DE); Tilo Koenig, Buehl (DE); Jerome Thiery, Strasbourg (FR)

(73) Assignee: ROBERT BOSCH GMBH, Stuttgart (DE)

(21) Appl. No.: 13/878,050

(22) PCT Filed: Aug. 26, 2011
(86) PCT No.: PCT/EP2011/064747

§ 371 Date: Apr. 5, 2013

(30) Foreign Application Priority Data
Oct. 7, 2010 (DE) 102010042133.2

(51) Int. Cl. H02K 1/18

(52) U.S. Cl. CPC H02K 1/185
USPC 310/216.131

(57) ABSTRACT

An electrical machine (100) comprises a housing (110), a stator (200) arranged in the housing and a conical spring washer (300), which holds the stator (200) in its installed position by means of a predetermined axial spring force (F_{A}). In this case, the conical spring washer (300) comprises an annular base body (310), which is attached to a housing inner wall (110) by means of an attachment device (330), as well as a number of spring structures (320) which extend from the annular base body (310) in the direction of the stator (200) and support the stator (200) axially.

### BACKGROUND OF THE INVENTION

The invention relates to a conical spring washer for mounting a stator in the housing of an electrical machine, in particular a cooling circuit pump in a motor vehicle. In addition, the invention relates to an electrical machine comprising such a conical spring washer.

Electrical machines are used in different technical applications. Thus, an EC motor comprising a rotating rotor and a stator fixedly arranged within the machine housing forms, for example, the electrical part of a cooling circuit pump. In this connection, the stator, which is configured from stamped sheet metal plates that are isolated from one another for the purpose of reducing eddy currents, is mechanically connected to the housing by means of screw connections, axial or radial bracings, adhesive bondings, shrink wraps or press fits or by a combination of several methods. Many of these methods have various disadvantages. The use of screw connections for mounting the stator is, for example, relatively installation space- and cost-intensive. In addition, the preload force of a screw connection is very temperature dependent and greatly decreases after a relatively short period of time when subjected to stress due to changes in temperature; and therefore the stator can move to a great extent independently of the inertia forces thereof. During the operation of the motor, the alternating electromagnetic fields constantly produce varying loads on the electrically and magnetically conductive motor components. The stator is thereby particularly subjected to high mechanical loads, which lead to shaking movements of the stator if the same is not sufficiently secured. In addition, the greatly varying thermal expansion between plastic as material of the housing and metal as material of the laminated core leads to relatively large tolerances, particularly in the case of high temperatures, and therefore to undesired free spaces for movement between the components.

As a function of the rigidity and joining technology of the individual components, the loads acting on the stator can be transferred as vibrations to other components of the motor. Particularly the contact pins disposed between the stator and printed circuit board react very sensitively to changing mechanical loads. In order to prevent these critical contacts from failing, it is necessary to provide appropriate measures for reducing the transmission of vibrations. For example, special damping elements are thus used for the targeted dampening of the vibrational excitations. The known damping elements, however, permit only small tolerance compensation. Depending on design and material used, the damping elements have only a limited range of application with regard to temperature. In contrast, alternative damping concepts prove to be complex and costly.

### SUMMARY OF THE INVENTION

It is therefore the aim of the invention to provide a mounting of the stator in the motor housing, which facilitates a reliable securing of the stator and at the same time compensates for movements of said stator. This aim is met by an electrical machine according to claim 1. Further advantageous embodiments of the invention are specified in the dependent claims.

According to the invention, an electrical machine comprises a housing, a stator arranged in the housing and a conical spring washer, which holds the stator in its installed position by means of an axial spring force. The conical spring washer thereby comprises an annular base body, which is attached to a housing inner wall by means of an attachment device as well as a number of spring structures which extend from the annular base body in the direction of the stator and support said stator axially by means of a predetermined spring force. By axially supporting the stator by means of spring structures, movements of the stator, as, e.g., expansion processes which are thermally caused, as well as tolerances caused by manufacture can be compensated. At the same time, a fixing of the stator in the housing with zero backlash is ensured by means of the conical spring washer. The spring structures furthermore have a dampening effect on high vibration accelerations of the stator. The conical spring washer further allows for a simple pre-financing of the stator prior to installing the rotor. With the aid of the inventive conical spring washer, a constant pre-tensioning force can be achieved across a large temperature range.

Provision is made in one embodiment for the spring structures to be configured in the form of bent sheet metal tongues. Such sheet metal tongues can be particularly easily manufactured. By selecting the suitable material, thickness, width and curvature of the sheet metal tongues, the resilient properties of the spring structures can be easily adapted to the respective requirements.

Provision is made in a further embodiment for the spring structures to be helically bent about the annular base body. The flat characteristic curve of the helical springs permits a greater spring deflection required for the tolerance compensation while optimally utilizing the installation space. It is therefore possible with the aid of the helically configured spring structures to selectively adjust the deflection behavior required for the respective application.

Provision is made in a further embodiment for the conical spring washer to comprise at least one limiting element for delimiting the maximum compression of the spring structures. With the aid of the limiting element, the maximum spring force can be set in a particularly easy manner. This facilitates on the one hand a monitoring of the installation force during the insertion of the conical spring washer into the housing chamber. On the other hand, the limiting element ensures that the spring is not excessively stressed. In so doing, the risk of a material failure can be reduced.

Provision is made in a further embodiment for the limiting element to be formed by an end section of the spring structure bent in the direction of the annular base body. Upon achieving maximum compression, said end section comes to rest on a locating surface of the annular base body. Such a limiting element can be particularly easily and cost-effectively manufactured.

Provision is made in a further modification for the attachment device to be designed in the shape of an expansion device disposed along the outer circumference of the annular base body. The expansion device is thereby disposed in a radially compressed manner within the housing such that a pressure exerted by said expansion device on the inner wall of the housing causes the conical spring washer to be fixed in the housing. This type of attachment permits an optimal compensation of the radial expansion of the housing. An expansion device further facilitates a simple mounting because the conical spring washer inserted into the apparatus housing is automatically fixed due to the expansion of the expansion device. This simple fixing of the conical spring washer further permits the attachment of the stator to be subsequently adjusted. Not least an expansion device can also be very easily and cost effectively manufactured from a suitable sheet metal in a forming process. Finally, the pre-tensioning force of the constituents is not transferred to other connections, as, for example, the screw connection between the pump housing and between housing or other plastic connections.

In an advantageous modification, the expansion device comprises a plurality of expansion wings arranged in a star-shaped pattern along the outer circumference of the annular base body. In so doing, the expansion wings can be disposed in a radially compressed manner within the housing such that a pressure exerted by the expansion wings onto the housing inner wall causes the conical spring washer to be fixed in the housing. Due to the higher resilience of the individual expansion wings vis-á-vis the closed expansion collar, an improved attachment of the conical spring washer is possible with the aid of said expansion wings. In addition, it can be selectively determined by means of said expansion wings how the forces of the stator are transferred via the conical spring washer to the housing and vice versa.

Provision is made in a further modification for the expansion wings to be disposed proximately in the region of the spring structures. In so doing, the force transmission between housing and stator is improved.

Provision is made in a further embodiment for the annual base body to comprise recessed sections, which engage in an interstice between each two pole shoes of the stator. The spring structures are thereby disposed in the recessed sections of the annular base body. In so doing, the installation height of the conical spring washer is reduced, which in the end means a lower installation height of the electrical machine.

Provision is made in a further embodiment for the conical spring washer to be designed as a component which is produced from spring steel by means of a stamping process. Such a conical spring washer can be cost-effectively manufactured. The use of spring steel facilitates an optimal and long-lasting spring function.

Finally, provision is made in a further embodiment for the electrical machine to be designed as a drive for a power unit in a motor vehicle. With the aid of the inventive conical spring washer, loads typically occurring during the operation of a motor vehicle can be compensated especially well.

### BRIEF DESCRIPTION OF THE DRAWINGS

The invention is described below in detail using the drawings. In the drawings:

FIG. 1 shows a perspective view of a partially assembled electrical machine according to the invention comprising a conical spring washer which fixes the stator;

FIG. 2 shows a cross-sectional view of the electrical machine from FIG. 1;

FIG. 3 shows a schematic cross-sectional view of the electrical machine according to the invention;

FIG. 4 shows a detailed view of the conical spring washer according to the invention from FIG. 3 to clearly illustrate the attachment;

FIG. 5 shows a further detailed view of the conical spring washer according to the invention from FIG. 3 to clearly illustrate the behavior when radial expansions of the housing occur;

FIG. 6 shows a perspective view of the upper side of an inventive conical spring washer comprising a circumferential collar element;

FIG. 7 shows a perspective view of the bottom side of the conical spring washer according to the invention;

FIG. 8 shows a cross-sectional depiction of the inventive conical spring washer comprising a limiting element for limiting the maximum compression of the spring structures;

FIG. 9 shows a detailed view of the limiting element from FIG. 8;

FIG. 10 shows a further embodiment of the inventive conical spring washer comprising expansion wings arranged in a star-shaped pattern along the outside circumference of the base body;

FIG. 11 shows an exploded view of the electrical machine according to the invention;

FIG. 12 shows a perspective view of the electrical machine according to the invention from FIG. 11 after assembly;

FIG. 13 shows a further embodiment of the inventive conical spring washer comprising recessed sections for the improved utilization of the available installation space;

FIG. 14 shows a further embodiment of the inventive conical spring washer comprising recessed sections;

FIG. 15 shows a partially assembled electrical machine comprising the conical spring washer from FIG. 14;

FIG. 16 shows a special embodiment of the inventive conical spring washer comprising helically bent spring structures;

FIG. 17 shows cross-sectional depictions of a helically bent spring structure in the loaded and unloaded state;

FIG. 18 shows a special embodiment of the inventive conical spring washer comprising helically bent spring structures and recessed sections.

### DETAILED DESCRIPTION

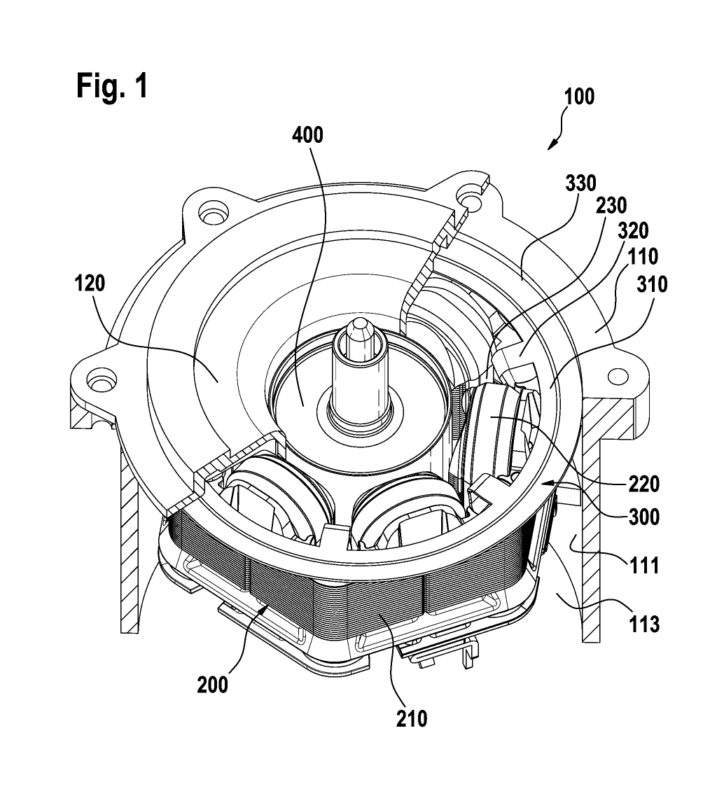

FIG. 1 shows a perspective view of the electrical machine 100 according to the invention. The electrical machine designed in the present example as the drive component of a fluid pump, in particular a cooling circuit pump, is thereby shown in a partially cut-away state. The electrical machine 100 comprises a housing 110, which is manufactured from a suitable material, such as, for example, plastic or metal, and comprises an inner chamber 113 having a substantially round cross-section, an annular stator 200 disposed in the housing chamber as well as a rotor 400 that engages into the annular stator 200. In the case of the fluid pump shown here, the rotor is disposed within an intermediate housing which separates the liquid-rinsed rotor chamber from the stator chamber. The intermediate housing is thereby formed from a covering element which closes the housing chamber on one side. According to the invention, the stator 200 is fixed in its installed position by means of a conical spring washer 300. As shown in FIG. 1, the conical spring washer 300 thereby comprises an annular base body 310 having a plurality of spring structures 320, which are disposed so as to be distributed along the annular base body 310 and which support the stator 200 in each case with predetermined regions between the pole shoes. In addition, the conical spring washer 300, which is preferably formed from spring steel, comprises an attachment device 330 that facilitates attachment in the housing 110. The attachment of the components in the motor housing is implemented by means of excess dimensions in the radial direction between conical spring washer and motor housing. For this purpose, the attachment device 330 is designed as an expansion device, which has a larger outside diameter than the inside diameter of the housing chamber 113 and therefore is disposed in a radially compressed manner within the housing chamber. The conical spring washer is fixed firmly within the housing chamber by means of the radial tensioning force, which the expansion element 330 thereby exerts on the housing inner wall 111, or respectively by the frictional force associated therewith. In the present exemplary embodiment, the expansion device is designed in the shape of a circumferential expansion collar.

The spring structures 320 are preferably designed as sheet metal strips which emanate from the annular base body 310 and are bent downwards in the direction of the stator. The conical spring washer 300 is thereby positioned such that the spring structures 320 support the stator 200 on the end face thereof with a predetermined spring force F_{A} and thus secure said stator in the intended installed position.

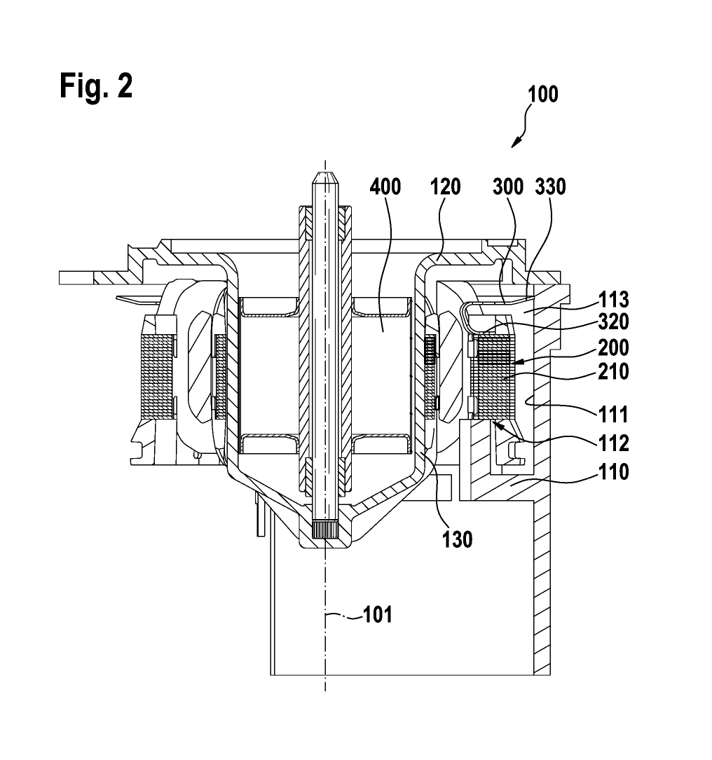

In order to clearly illustrate the stator attachment, FIG. 2 shows a cross-sectional view through the electrical machine 100 from FIG. 1. The stator 200 is thereby supported on a housing part 112, which forms the seat for the stator, with the face thereof that is opposite the end face accommodating the conical spring washer 300. The stator 200 is pressed against the housing part by means of the pressure exerted by the conical spring washer 300. Due to the resilient properties of the spring structures 320 and the expansion elements 330, said conical spring washer 300 ensures a fixing of the stator 200 with zero backlash as well as an axial tolerance compensation between stator 200 and housing 110. For that reason, the different thermal expansion behavior of the stator 200 and the housing 110 can be effectively compensated.

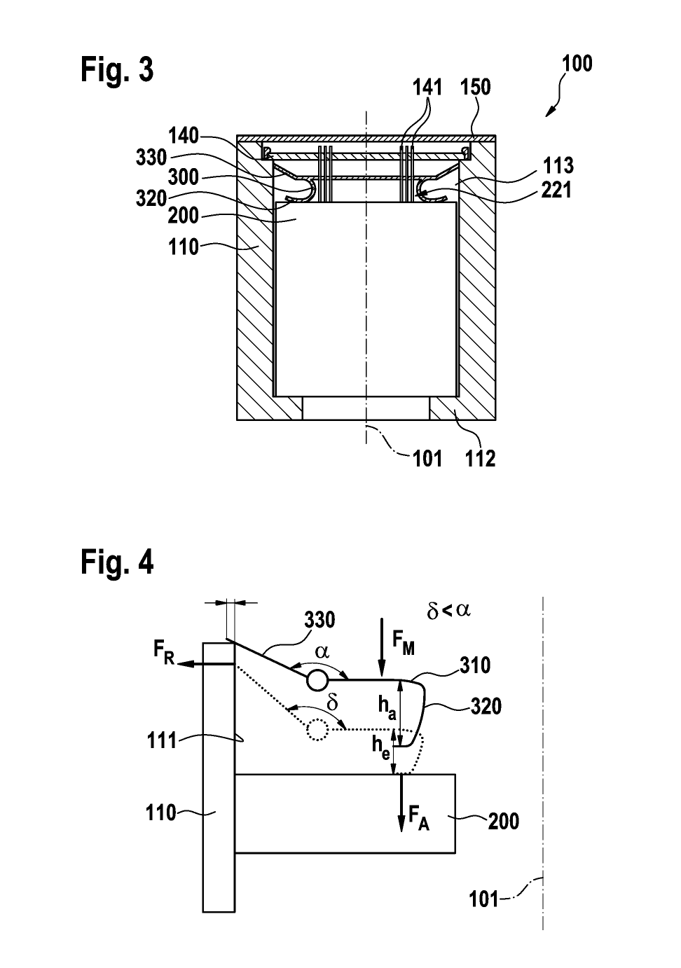

In order to clearly illustrate the manner in which the stator is attached, FIG. 3 shows a schematic cross-sectional depiction through an electrical machine 100 according to the invention. As was already explained in connection with FIGS. 1 and 2, the stator 200 is accommodated in an inner chamber 113 of the housing 110. The stator 200 thereby lies with the lower part thereof on the lower housing part 112 that serves as a seat and is delimited in the upper part thereof by the conical spring washer 300 which is inserted into the housing chamber 113. The fixing of the conical spring washer in the housing occurs by means of the expansion device 330, which is accommodated in the housing in a radially compressed manner. The outer edges of said expansion device 330 are pressed against the housing inner wall and thus grip the conical spring washer 300 in the housing.

The spring elements 320 provided for fixing the stator support the stator 200 on the end face thereof with a spring force acting axially in the direction of said stator. Said spring force is predetermined during installation with the conical spring washer 300 and can be adapted to the respective demands. The resilient support permits an axial expansion of the stator and at the same time compensates for tolerances between housing 110, stator 200 and conical spring washer 300. In this manner, manufacturing tolerances of the different components, such as laminated core height, axial stop at the motor housing or diameter of the motor housing, can be compensated. In addition, expansion processes of the laminated core having a thermal origin can be especially simply compensated in the axial direction. Dynamic forces, as they arise, for example, as a result of vibrations of the machine or as a result of electromagnetic torques during operation, can however also be effectively intercepted by means of the resilient properties of the conical spring washer.

The windings of the stator (not shown here) are electrically connected to a printed circuit board, which is disposed in a cover-like manner in the upper region of the housing chamber. The contacting takes place by means of pencil-shaped contact pins 141, which are electrically connected to the printed circuit board 140. Such contact pins 114 represent typical weak spots in the electrical current circuits. The soldered joints of the contact pins 141 among other things can be mechanically weakened by the alternating movement of the stator. Because the vibrations of the stator are significantly reduced by the resilient support by means of the conical spring washer, the risk of a mechanical weakening of the contact pins and a breakdown of the corresponding electrical connections in conjunction therewith is reduced.

The attachment of the conical spring washer 300 within the housing is explained below in detail. In this connection, FIG. 4 schematically depicts a partial view of the conical spring washer 300 from FIG. 3 prior to and after installation within the housing 110. The arrangement depicted here is rotationally symmetric, which is illustrated by means of the indicated axis of rotation 101. In the dismantled state of the conical spring washer 300, the expansion element 330, which is bent upwards, and the base body 310 enclose an obtuse angle α. As depicted here, the outside diameter of the conical spring washer 300 is thereby designed somewhat larger than the inside diameter of the housing 110; thus enabling the expansion device 330 to slightly protrude beyond the housing chamber. The spring element 320 configured in the form of a bent sheet metal tongue has a specific installation height hₐ in the untensioned state.

In order to install the conical spring washer 300, said washer is pressed into the housing chamber 113 by applying an installation force F_{R} until the lower section of the spring element 320 seats against the stator 200. The spring element 320 compresses by being pushed down further. The resiliently pre-tensioned spring element 320 now exerts an axial contact pressing force F_{A}, which fixes the stator 200 against the seat thereof, to an upper region of the stator 200. As is shown in FIG. 4 by means of the dashed line, the installation height hₐ turns out to be smaller in the installed state.

As is further depicted in FIG. 4, the conical spring washer 300 is radially compressed as a result of being pressed into the housing chamber. This compression is preferably achieved by means of a resilient deflection of the expansion element 330. It can be seen in the drawing that the angle * between the expansion element 330 and the annular base body 310 of the conical spring washer is smaller than the angle α. As is indicated by an arrow, the resiliently deformed expansion element 330 now exerts a specific force F_{R} on the housing wall 111, by means of which said conical spring washer 300 is fixed within the housing chamber. The amount of this expansion force depends primarily on the properties of the expansion element 330, such as, e.g., the material and the thickness of the sheet metal used, the axial length of said expansion element and the strength of curvature of said expansion element.

Whereas small rotor movements, such as, e.g., the vibrations that typically take place during operation, can already be compensated for with the aid of the spring elements 320, the resilient expansion elements acting as additional spring elements also allow for an effective compensation of larger axial movements of the rotor, such as, e.g., a thermal expansion of the metal sheet stack during an intensive operation of the motor.

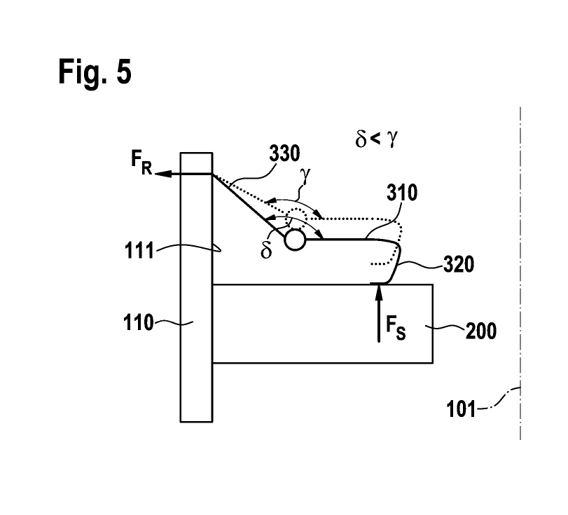

As is shown in FIG. 5, the expansion element 330, by means of the resilient properties thereof, can substantially compensate for a lifting of the conical spring washer by the rotor without the anchorage point of said expansion element 330 at the housing inner wall 111 being displaced. The force of the stator F_{S} acting on the clamping ring is thereby diverted via the spring element 320, the annular base body 310 and the expansion element 330 to the housing inner wall 111; and therefore only the expansion angle between the expansion element 330 and the annular base body 310 changes in the process.

The shape of the clamping ring can vary according to application. It is thereby useful in principle to support the rotor at a plurality of support points symmetrically distributed across the circumference thereof. The support points thereby preferably form the grooves disposed between the pole shoes of the stator.

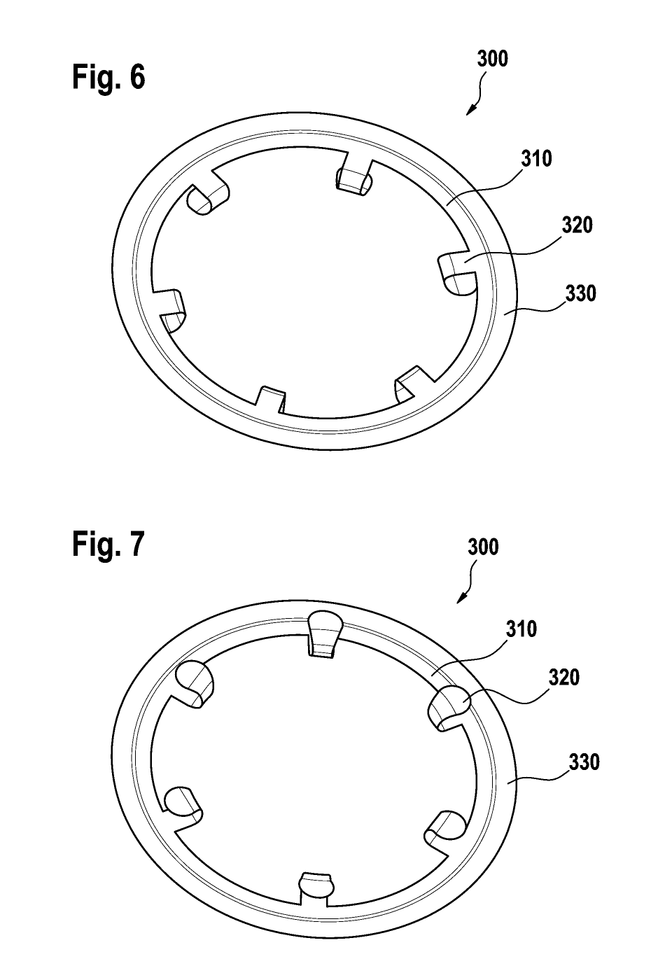

FIGS. 6 and 7 shown in an exemplary manner the conical spring washer of the electrical machine depicted in FIG. 1. The conical spring washer 300 formed from spring steel by means of suitable deformation processes comprises an annular base body 310, a collar-shaped expansion element 330 extending along the outer circumference of the base body as well as in total six spring elements 320 disposed in a uniformly distributed manner along the inner circumference of the base body. The spring elements 320 extending in the axial direction are thereby designed in the shape of sheet metal lugs emanating from the annular round body and bent about an angle of approximately 180E. In FIG. 7, the bottom side of the conical spring washer 300, which comprises spring elements now extending radially upwards, is depicted.

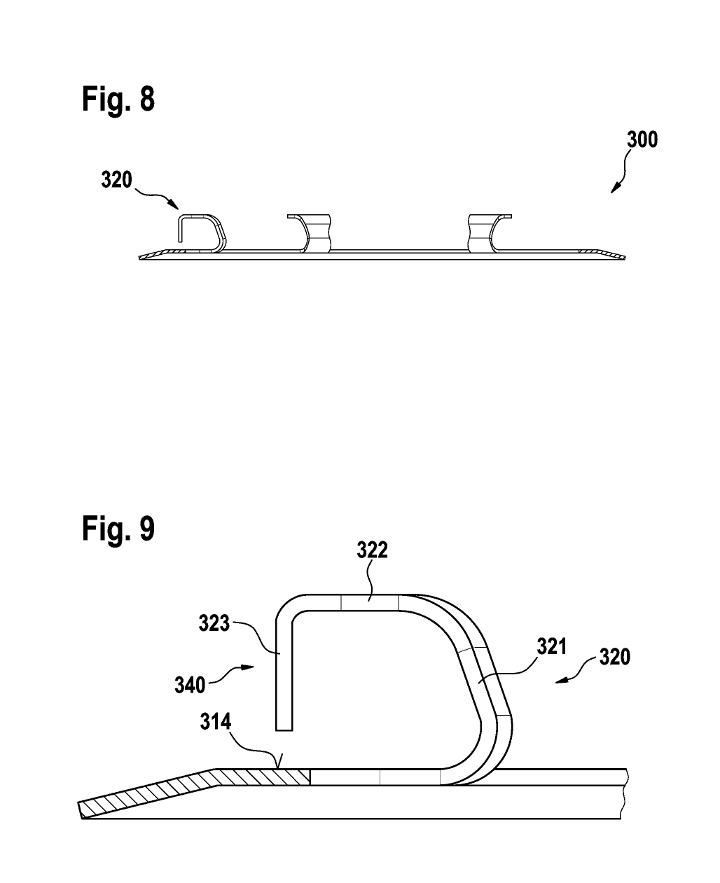

In order to delimit the deflection of the spring elements, provision can be made for corresponding limiting elements. Such a limiting element can, for example, be configured in the shape of an end section of a spring structure bent in the direction of the annular base body. FIG. 8 shows a cross-section through a conical spring washer 300 comprising such a limiting element. As can be seen in FIG. 9, which shows a detailed view of the spring element 320 from FIG. 8, the limiting element 340 is formed from an end section 323 of the spring element 320, which end section is bent in the direction of a locating surface 114 of the annular round body. Upon achieving the maximum compression of the spring element 320, the limiting element 340 abuts against the locating surface 314 and consequently prevents a compression of the spring element 320 which exceeds this amount.

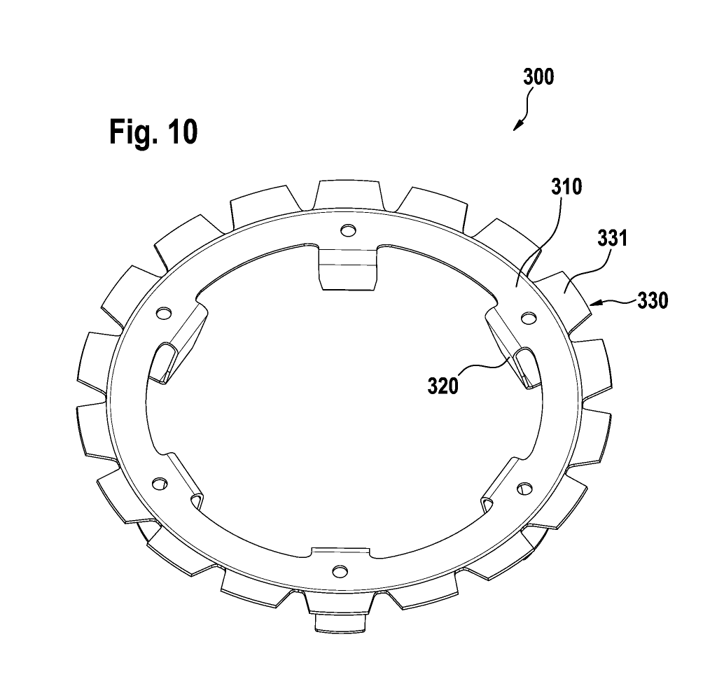

Further concepts of the conical spring washer according to the invention are described below, which may be used depending upon the application. Thus, a plurality of expansion wings distributed along the outer circumference of said washer can, for example, be used instead of an expansion collar. By way of example, FIG. 10 shows such a conical spring washer 300 having in total 18 expansion wings 330 distributed in a star-shaped pattern along the outer circumference of the annual base body 310. Because the individual expansion wings 330 can deform independently of one another, a greater radial compression of the conical spring washer is possible within the motor housing. For that reason, greater radial tolerances of the motor housing can thereby be compensated. The boreholes provided along the circumference of the annular base body serve to align the conical spring washer during installation. This can also be achieved with the aid of corresponding recesses in the base body (not shown here). In this way, corresponding supporting surfaces for assembly plungers can be implemented.

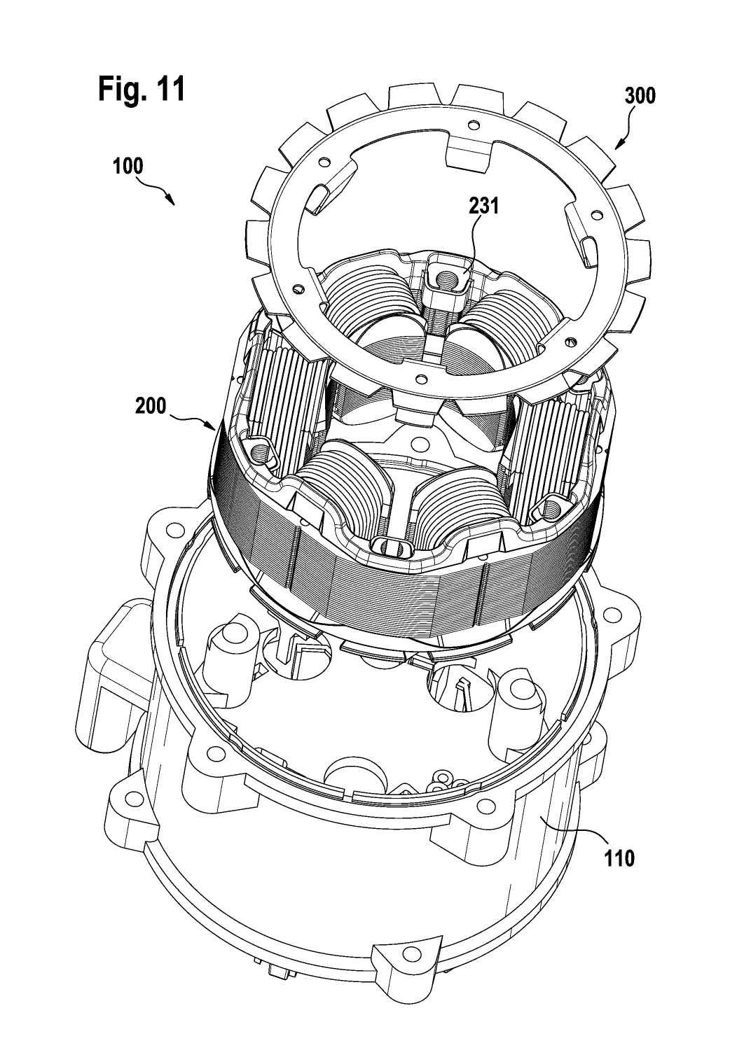

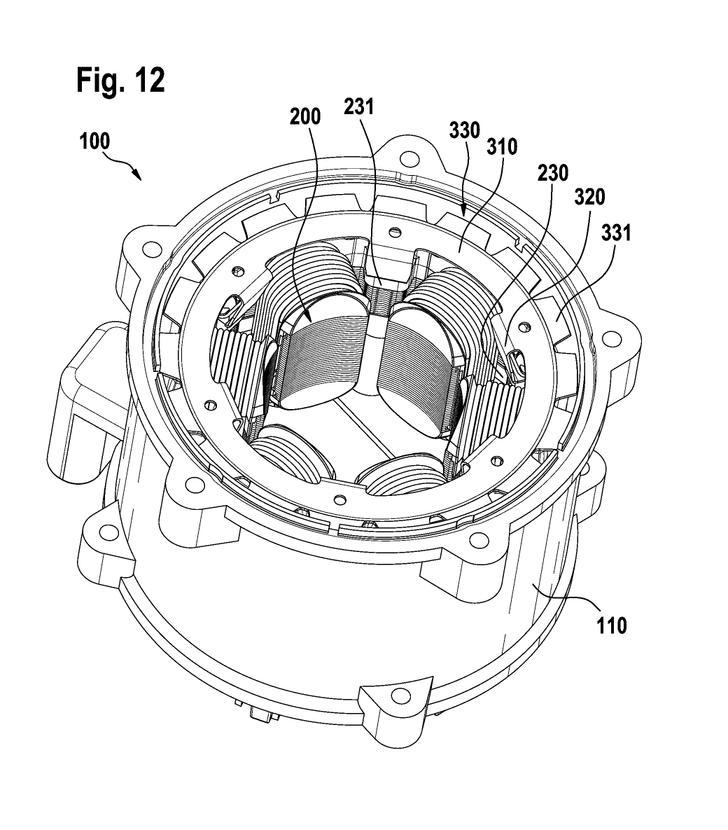

FIG. 11 shows an exploded view of the inventive electrical machine 100 comprising the conical spring washer from FIG. 10. The electrical machine 300 comprises a housing 110, a stator 200 which can be inserted into the housing and a corresponding conical spring washer 300 for securing the stator 200 in the housing 110. FIG. 12 shows the electrical machine from FIG. 11 in the assembled state. It can be seen here that the conical spring washer 300 secures the stator 200 within the housing chamber 110 by means of an axial resilient force. To this end, the spring elements 320 engage into the interstices between two respective pole shoes 220 of the stator 200. Each spring element 320 thereby presses onto a special supporting surface 231 configured in the grooves 230 of the stator 200 with a predetermined supporting force. The conical spring washer 300 is attached within the housing 110 by means of the expansion elements 320 designed in a wing-like fashion, which are resiliently pre-tensioned against the housing inner wall 111. Due to the special arrangement of the expansion elements 320 on the side of the annual base body 310 facing away from the stator 200, the stator forces are effectively diverted via the conical spring washer 300 to the housing inner wall 111.

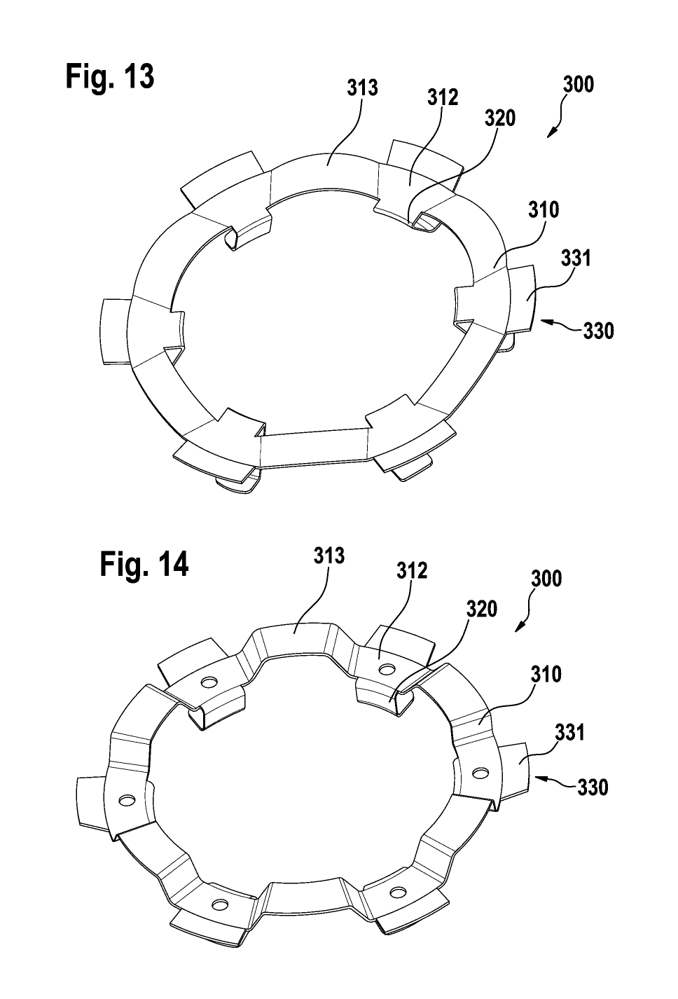

The special embodiment of the conical spring washer can be adapted to the needs of the respective application. Conical spring washers, in which the expansion elements are disposed in recessed sections of the annular base body, can thus, for example, be used to reduce the installation space. FIGS. 13 and 14 show two examples of such a conical spring washer. The conical spring washer shown in FIG. 13 thereby comprises a base body of wave-like design having in each case alternating recessed and elevated sections 312, 313. The spring elements 320 supporting the stator as well as the expansion elements 330 serving to attach said conical spring washer 300 are thereby disposed in each case in the recessed sections 312, which are provided for the engagement into the grooves of the stator. In contrast to the conical spring washer from FIG. 13, the annular base body 310 of the conical spring washer shown in FIG. 14 is designed in a stepped manner. This embodiment allows for as greater height difference between the recessed and the elevated sections 312, 313.

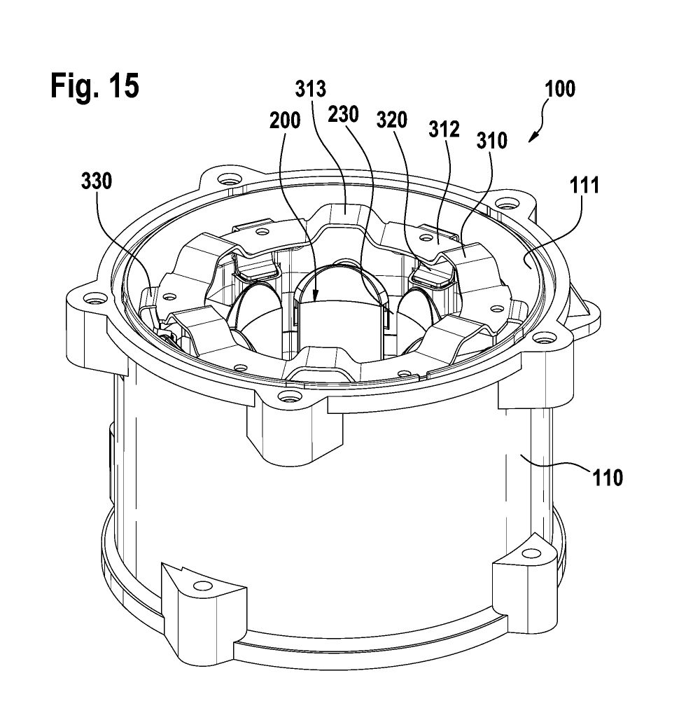

FIG. 15 shows an electrical machine 100 according to the invention having a conical spring washer 300 formed in a correspondingly stepped manner. As can be seen from this perspective view, the recessed sections 312 of the annual base body 310 engage into the grooves 230 of the stator 200 disposed between each two pole shoes 220. The spring elements thereby support the stator at suitably designed supporting points 231. FIG. 15 shows a special embodiment of the conical spring washer, in which the spring elements 320 are used at the same time to attach the conical spring washer 300 within the housing 110. The spring elements 320 which are bent to excess dimensions are inserted into the housing chamber 111 in a radially compressed manner. The radial restoring force of the spring elements 320 tensions the conical spring washer within the housing 110.

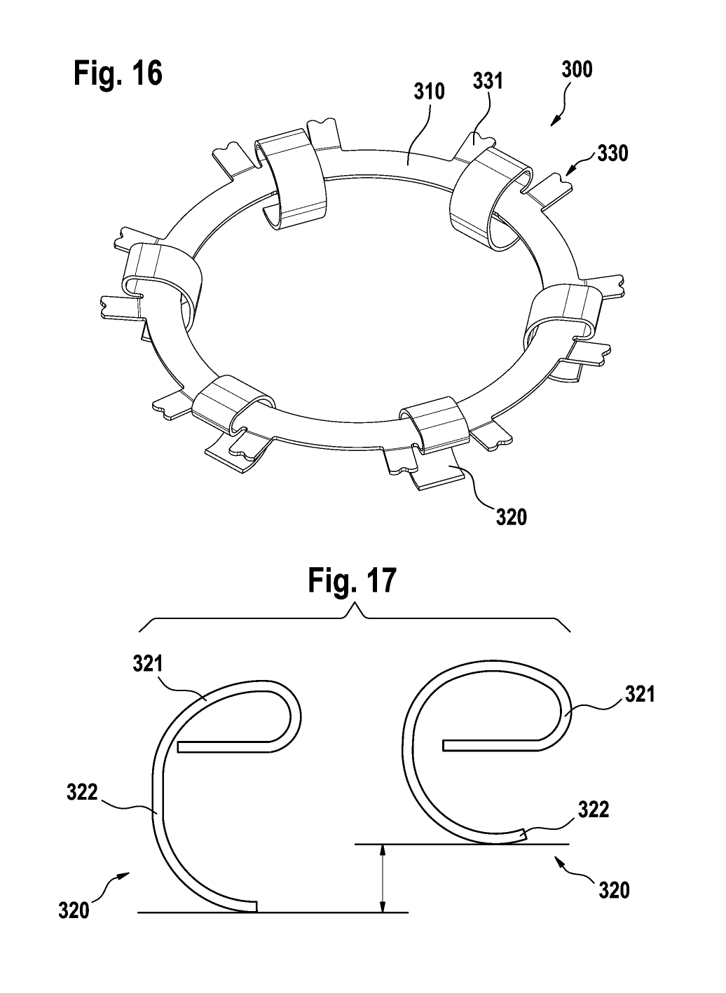

In order to implement a greater spring deflection, spring elements 320 can be used, which are helically bent around the annular base body 310. FIG. 16 shows a special conical spring washer 300 comprising six correspondingly shaped spring elements 220. In this case, the individual spring elements are formed from relatively long, sheet metal tongues emanating at the outer circumference of the annular base body 310. The expansion elements 330 which are likewise disposed on the outer circumference of the annular base body 310 are respectively disposed in this example on both side of a spring element. The arrangement of the expansion elements 330, which is symmetrical with respect to the spring elements 320, facilitates a more uniform distribution of force.

As previously mentioned, the larger axial expansion of the spring elements 320 basically permits a larger resilient compression. FIG. 17 shows by way of example the behavior of a helically configured spring structure 320 when being compressed, for example, as a result of a movement of the stator 200. The helical spring 320 shown on the left side of FIG. 17 comprises a upper spring component 321 and a lower spring component 322 and is in an untensioned or only slightly compressed state as is, for example, the case prior to installing the conical spring washer.

In the case of said helical spring, an axial load on the spring causes a compression of the lower spring component 322 and simultaneously causes the upper spring component 321 to bend upwards. On the right side of FIG. 17, the helical spring 320 is depicted in the corresponding loaded state, which can, for example, result after inserting the conical spring washer into the housing. By means of the helical design of the spring, the maximum spring deflection is automatically delimited as soon as the lower end section of the spring element 320 comes in contact with the annular base structure.

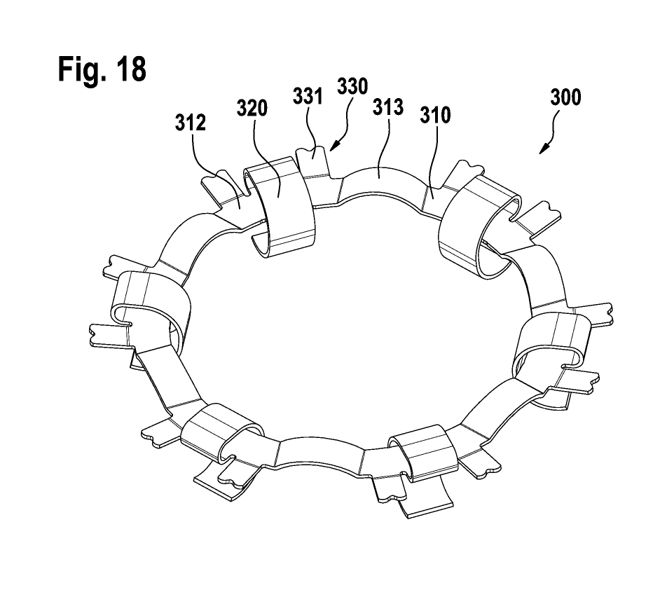

Due to the behavior of the spring elements under load, which is illustrated in FIG. 17, it can be useful to design the annular base body of the conical spring washer depicted in FIG. 17 in a wavelike manner in order to delimit the installation height. FIG. 18 shows a corresponding conical spring washer 300, the annular base body 310 of which has alternating recessed and elevated sections 312, 313. The spring structures 320 as well as the expansion elements 330 are thereby preferably disposed in the recessed sections 312 of the base body 310.

1. An electrical machine (100) comprising a housing (110), a stator (200) arranged in the housing and a conical spring washer (300), which holds the stator (200) in an installed position by means of a predetermined axial spring force (F_{A}), wherein the conical spring washer (300) comprises an annular base body (310), which is attached to a housing inner wall (110) by an attachment device (330), and a number of spring structures (320) which extend from the annular base body (310) in the direction of the stator (200) and support said stator (200) axially by means of the spring force (F_{A}).

2. The electrical machine according to claim 1, wherein the spring structures (320) are designed in the shape of bent sheet metal tongues.

3. The electrical machine (100) according to claim 1, wherein the spring structures (320) are helically bent around the annular base body (310).

4. The electrical machine (100) according to claim 1, wherein the conical spring washer (300) comprises at least one limiting element (340) for delimiting the maximum compression of the spring structures (320).

5. The electrical machine (100) according to claim 4, wherein the limiting element (340) is formed by an end section (323) of the spring structure (320) which is bent in the direction of the annular base body (310) and which comes to rest on a locating surface (314) of said annular base body (310) upon achieving maximum compression.

6. The electrical machine (100) according to claim 1, wherein the attachment device (330) is designed in the form of an expansion device disposed along the outer circumference (311) of the annular base body (310), wherein the expansion device (330) is disposed within the housing (110) in a radially compressed manner such that a pressure exerted by said expansion device (330) onto the housing inner wall (111) causes the conical spring washer (300) to be fixed in said housing (110).

7. The electrical machine (100) according to claim 6, wherein the attachment device (330) comprises a plurality of expansion wings (331) arranged in a star-shaped pattern along the outer circumference (311) of the annular base body (310), wherein the expansion wings (331) are disposed within the housing (110) in a radially compressed manner such that a pressure exerted by said expansion wings (331) onto the housing inner wall (111) causes the conical spring washer (300) to be fixed in said housing (110).

8. The electrical machine (100) according to claim 7, wherein the expansion wings (331) are in each case associated in pairs with a common spring structure (320) which is disposed in each case between the two expansion wings (331).

9. The electrical machine (100) according to claim 1, wherein the annular base body comprises recessed sections (312) which engage into an interstice (230) between each two pole shoes (220) of the stator (200) and wherein the spring structures (320) are disposed in the recessed sections (312) of the annular base body (310).

10. The electrical machine (100) according to claim 1, wherein the conical spring washer (300) is designed as a component produced from spring steel by means of a stamping process.

11. The electrical machine (100) according to claim 1, wherein the electrical machine (100) is designed as a drive for a power unit in a motor vehicle.
